(19) United States
(12) Patent Application Publication
(10) Pub. No.: US 2023/0231859 A1
(43) Pub. Date: Jul. 20, 2023

(54) OUTPUT OF BASELINE BEHAVIORS CORRESPONDING TO FEATURES OF ANOMALOUS EVENTS

(71) Applicant: Microsoft Technology Licensing, LLC, Redmond, WA (US)

(72) Inventors: Idan Yehoshua HEN, Tel Aviv (IL); Andrey KARPOVSKY, Kiryat Motzkin (IL)

(73) Assignee: Microsoft Technology Licensing, LLC, Redmond, WA (US)

(21) Appl. No.: 17/578,145

(22) Filed: Jan. 18, 2022

(51) Int. Cl. H04L 9/40

(52) U.S. Cl. CPC H04L 63/1425

(57) ABSTRACT

According to examples, an apparatus may include a processor and a memory on which is stored machine-readable instructions that when executed by the processor, may cause the processor to determine baseline behaviors from collected data. The processor may also detect that an anomalous event has occurred and may determine at least one feature of the anomalous event that caused the event to be determined to be anomalous. The processor may further identify, from the determined baseline behaviors, a set of baseline behaviors corresponding to the determined at least one feature. The processor may still further generate a message to include an indication that the anomalous event has been detected and the identified set of baseline behaviors and may output the generated message.

### BACKGROUND

New types of attacks on computer security are being developed and put into use by malicious individuals and organizations. Some attacks have consequences that are relatively easy to detect, such as distributed denial of service (DDOS) attacks or physical attacks such as bombs, earthquakes, or power grid shutdowns. Other attacks are more difficult to detect, such as data theft or malware infection, which may have consequences that may go undetected for a long time or until a large portion of the computing system is implicated, or both. The attacks may rely mainly or entirely on overcoming, tricking, or evading software protections, such as anti-malware software or firewalls or encryptions. Other attacks may rely in some critical way on overcoming, tricking, or evading human precautions.

### BRIEF DESCRIPTION OF DRAWINGS

Features of the present disclosure are illustrated by way of example and not limited in the following figure(s), in which like numerals indicate like elements, in which:

FIG. 1 shows a block diagram of a network environment, in which an apparatus may generate and output a message that includes an identified set of baseline behaviors corresponding to at least one feature of an event that caused the event to be determined to be anomalous, in accordance with an embodiment of the present disclosure;

FIG. 2 depicts a block diagram of the apparatus depicted in FIG. 1, in accordance with an embodiment of the present disclosure;

FIG. 3 depicts a flow diagram of a method for generating and outputting a message that includes an identified set of baseline behaviors that correspond to at least one feature of an anomalous event, in accordance with an embodiment of the present disclosure; and

FIG. 4 shows a block diagram of a computer-readable medium that may have stored thereon computer-readable instructions for generating and outputting a message that includes an identified set of baseline behaviors that correspond to at least one feature of an anomalous event, in accordance with an embodiment of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Anomaly detection is a widely used tool in the world of cyber security, where deviations from the norm may suggest that a malicious activity has occurred. Anomaly detection methods may be effective in identifying anomalous computing or networking activities. However, end users may find it difficult to understand the anomalous activities identified by the anomaly detection methods. This may be due to the complex and non-transparent inner workings of models that may execute the anomaly detection methods. As a result, regardless of the basis for which activities were determined to be anomalous, the end users may perform additional analysis on the anomalous activities to determine whether the anomalous activities are malicious or innocuous, e.g., not malicious. The end users may thus perform the additional analysis on activities that are innocuous. A technical issue with known anomaly detection methods may be that a relatively large amount of processing and energy resources may be used in the performance of the additional analysis of the anomalous activities. In many instances, the usage of the processing and energy resources may be wasted due to the activities being determined to be innocuous.

Disclosed herein are apparatuses, methods, and computer-readable media for generating and outputting a message that includes an identified set of baseline behaviors that correspond to at least one feature of an anomalous event. In some examples, the identified set of baseline behaviors may correspond to at least one feature of the event that caused the event to be determined to be anomalous. In this regard, the identified set of baseline behaviors may provide context as to why the event was determined to be anomalous. As discussed herein, the baseline behaviors may correspond to at least one feature of an event that has been identified as being normal or usual for the events. The baseline behaviors may also include top-k seen values of the features of events, usage statistics of the features, a first seen date of the events, a last seen date of the events, combinations thereof, and/or the like. In addition, the message may be generated through insertion of the identified set of baseline behaviors into a textual template.

According to examples, the baseline behaviors may be determined through an analysis of data collected regarding a plurality of events over a period of time. For instance, the baseline behaviors may include a number of times each type of event occurred over the period of time, from which countries each type of event originated, a count of the times each type of event originated from the countries, the first dates and/or times that each type of event occurred, the last dates and/or times that each type of event occurred, the source and/or destination IP addresses of each type of event that occurred over the period of time, and/or the like.

According to examples, an event may be determined to be anomalous based on a determination that at least one of the features of the event deviates from the baseline behavior corresponding to the at least one feature. By way of example in which a feature of an event is a geographical location from which the event originated, the event may be determined to be anomalous when the geographical location from which the event originated differs from normal geographical locations from which similar types of events originated. In this example, the normal geographical locations (set of baseline behaviors) from which the similar types of events originated may be identified. In addition, a message may be generated to include an indication that the anomalous event has been detected. The message may also include the normal geographical locations from which the similar types of event originated. As a result, the recipient, e.g., end user, of the message may determine from the message what the normal geographical locations are for similar types of events. As discussed herein, the message may include a number of other types of baseline behaviors to provide the recipient with additional information.

As discussed herein, a message (which may also equivalently be referenced herein as an alert, a notification, a link to information, etc.) that provides context as to why an event has been determined to be anomalous may be provided to an end user. The message may also provide context as to what the normal features are for the event. The end user may be, for instance, an administrator, a security analyst, a client, and/or the like. The end user may therefore be provided with a greater, e.g., sufficient, level of information regarding anomalous events, which may enable the end users to make more informed decisions as to which anomalous events to investigate further. As a result, the end users may, in many instances, determine that certain anomalous events may not need further investigation. For instance, an end user may determine that an anomalous event may not need further investigation when the end user determines that the cause (e.g., feature) of the event being determined to be anomalous is not a deviation from the norm. As another example, an end user may determine that an anomalous event may not need further investigation when the end user determines that the context pertaining to the cause of the event being determined to be anomalous does not warrant the further investigation.

Therefore, through implementation of various features of the present disclosure, a number of anomalous events for which an end user may perform further investigation may significantly be reduced. A technical improvement afforded through implementation of the various features of the present disclosure may thus be that the amount of processing and energy resources in determining whether anomalous events are malicious may significantly be reduced. The number of anomalous events for which the further investigation may be performed may be reduced without significantly reducing the identification of malicious events.

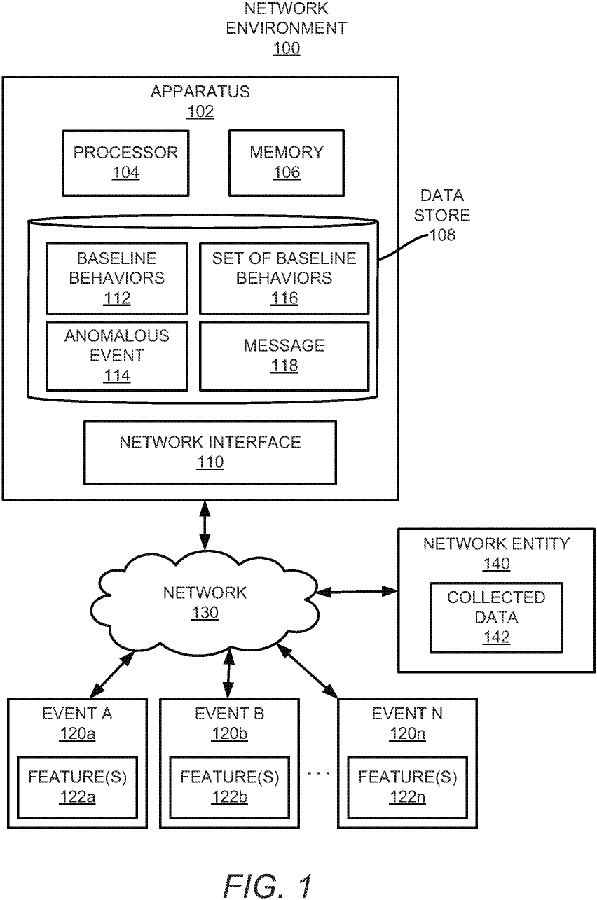

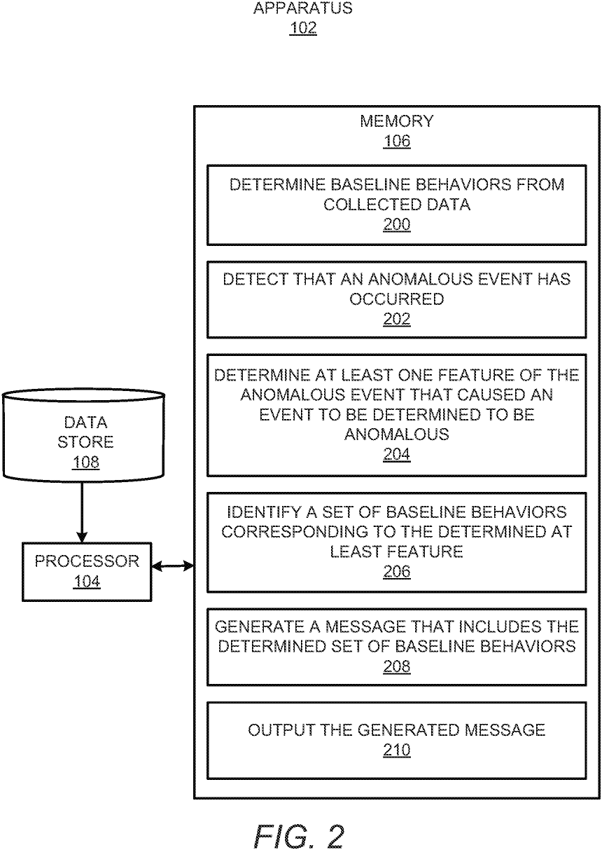

Reference is first made to FIGS. 1 and 2. FIG. 1 shows a block diagram of a network environment 100, in which an apparatus 102 may generate and output a message that includes an identified set of baseline behaviors corresponding to at least one feature of an event that caused the event to be determined to be anomalous, in accordance with an embodiment of the present disclosure. FIG. 2 depicts a block diagram of the apparatus 102 depicted in FIG. 1, in accordance with an embodiment of the present disclosure. It should be understood that the network environment 100 and/or the apparatus 102 may include additional features and that some of the features described herein may be removed and/or modified without departing from the scopes of the network environment 100 and/or the apparatus 102.

As shown in FIG. 1, the network environment 100 may include the apparatus 102, events 120a-120n (in which the variable “n” may denote a value greater than one), a network 130, and a network entity 140. The apparatus 102 may be a computing device such as a server, a laptop computer, a desktop computer, a tablet computer, and/or the like. In particular examples, the apparatus 102 is a server on the cloud. In some examples, functionalities of the apparatus 102 may be spread over multiple apparatuses 102, multiple virtual machines, and/or the like. The network 130 may be an internal network, such as a local area network, an external network, such as the Internet, or a combination thereof.

As shown in FIGS. 1 and 2, the apparatus 102 may include a processor 104 that may control operations of the apparatus 102. The apparatus 102 may also include a memory 106 on which instructions that the processor 104 may access and/or may execute may be stored. In addition, the processor 104 may include a data store 108 on which the processor 104 may store various information. The processor 104 may be a semiconductor-based microprocessor, a central processing unit (CPU), an application specific integrated circuit (ASIC), a field-programmable gate array (FPGA), and/or other hardware device.

The memory 106 and the data store 108, which may also each be termed a computer readable medium, may each be, for example, a Random Access memory (RAM), an Electrically Erasable Programmable Read-Only Memory (EEPROM), a storage device, or the like. The memory 106 and/or the data store 108 may be a non-transitory computer readable storage medium, where the term “non-transitory” does not encompass transitory propagating signals. In any regard, the memory 106 may have stored thereon machine-readable instructions that the processor 104 may execute. The data store 108 may have stored thereon data that the processor 104 may enter or otherwise access.

Although the apparatus 102 is depicted as having a single processor 104, it should be understood that the apparatus 102 may include additional processors and/or cores without departing from a scope of the apparatus 102. In this regard, references to a single processor 104 as well as to a single memory 106 may be understood to additionally or alternatively pertain to multiple processors 104 and/or multiple memories 106. In addition, or alternatively, the processor 104 and the memory 106 may be integrated into a single component, e.g., an integrated circuit on which both the processor 104 and the memory 106 may be provided. In addition, or alternatively, the operations described herein as being performed by the processor 104 may be distributed across multiple apparatuses 102 and/or multiple processors 104.

According to examples, the events 120a-120n may each be a network-related event, a computing device-related event, a communication-related event, and/or the like. For instance, the events 120a-120n may be attempted and/or successful accesses by users to resources. The users may be clients, employees, students, malicious entities, bots, and/or the like. The events 120a-120n, which may similarly be construed as activities, may include log-in attempts to the resources, successful log-ins to the resources, authentication attempts, modifications to data stored in the resources, successful or unsuccessful attempts to access the resources, copying of data contained in the resources, deletion of data contained in the resources, sending of messages using or through the resources, and/or the like. The resources may be computing devices, network appliances, data centers, servers, applications stored and/or executing on computing devices, data stores in or connected locally to computing devices, remote servers, remote data stores, web-based applications or services, applications stored and/or executing on servers, and/or the like.

According to examples, an entry into a log may be made each time that the events 120a-120n occur. For instance, a network entity 140 may enter data pertaining to the events 120a-120n into the log when the events 120a-120n are detected. The network entity 140 may be a data collector device and/or software that may be connected to network devices such as switches, routers, hosts, and/or the like. The network entity 140 may be a server or other device that may collect the data in any suitable manner.

The network entity 140 may collect data 142 such as source addresses, destination addresses, source ports, destination ports, and/or the like pertaining to features 122a-122n of the events 120a-120n. The features 122a-122n of the events 120a-120n may also include data pertaining to geographic locations at which the events 120a-120n occurred, the dates and times at which the events 120a-120n occurred, the types of applications through which the events 120a-120n occurred, the type of the event 120a-120n, a type of the entity that initiated the event 120a-120n, and/or the like. The geographic locations may include, for instance, the countries, states, localities, cities, and/or the like from which the events 120a-120n originated.

According to examples, baseline behaviors 112 for a plurality of the events 120a-120n may be determined from the collected data 142. The baseline behaviors 112 may include behaviors or features 122a-122n that may be construed as being “normal.” For instance, the baseline behaviors may include features 122a-122n of events 120a-120n that have been collected over a period of time, such as over a week, a month, a quarter, and/or the like. In addition, the baseline behaviors may include features 122a-122n for events 120a-120n that have not been identified as being malicious.

According to examples, the baseline behaviors may include usage statistics, such as, a number of occurrences for each category of events 120a-120n, when the occurrences of the events 120a-120n were first detected, when the occurrences of the events 120a-120n were last seen, a total number of events 120a-120n in each category, and/or the like. The baseline behaviors may additionally include a top-k seen values of the features 122a-122n of the events 120a-120n, in which the variable k may correspond to geographic locations, types of applications through which the events 120a-120n were performed, types of entities that initiated the events 120a-120n, and/or the like. By way of example in which k corresponds to geographic locations, the top-k seen values may include the countries from which the events 120a-120n were initiated. The top-k seen values may also include the number of times the events 120a-120n were initiated from which of the countries.

In some examples, the network entity 140 may determine the baseline behaviors 112 from the collected data 142. In these examples, the processor 104 may determine the baseline behaviors 112 through receipt of the baseline behaviors 112 from the network entity 140. In other examples, the processor 104 may determine the baseline behaviors 112 from the collected data 142. For instance, the processor 104 may access the collected data 142 through a network interface 110 via the network 130 and may determine the baseline behaviors 112 from the accessed data 142. The network interface 110 may include hardware and/or software that may enable data to be sent and received via the network 130.

As shown in FIG. 2, the memory 106 may have stored thereon machine-readable instructions 200-210 that the processor 104 may execute. As shown, the processor 104 may execute the instructions 200 to determine the baseline behaviors 112 from the collected data 142. As discussed above, in some examples, the processor 104 may determine the baseline behaviors 112 of the events 120a-120n from the collected data 142. In other examples, the network entity 140 may determine the baseline behaviors 112 of the events 120a-120n and the processor 104 may receive or otherwise access the baseline behaviors 112 from the network entity 140.

According to examples, the processor 104 may determine whether events, e.g., events 114 occurring in the network environment 100, are anomalous or whether the events are innocuous. For instance, the processor 104 may receive information regarding events occurring in the network environment 100 from devices in the network environment 100 in or on which the events have occurred. In addition, or in other examples, the processor 104 may receive the information from network appliances in the network environment 100, for instance, through which packets of data corresponding to the events flow. In some examples, the processor 104 may determine the geographical locations from which the events 120a-120n occurred from the source IP addresses included in the packets of data corresponding to the events 120a-120n.

The processor 104 may execute the instructions 202 to detect that an anomalous event 114 has occurred. The processor 104 may detect that the anomalous event 114 has occurred in any of a number of suitable manners. For instance, the processor 104 may apply a machine learning model to the feature(s) of the event 114, in which the machine learning model is to determine whether the event 114 is anomalous based on the feature(s) of the event 114. The machine learning model may be any suitable type of machine learning model, such as an autoencoder neural architecture, supervised learning model, unsupervised learning model, reinforcement learning, linear regression, decision tree, Naive Bayes, k-nearest neighbors, and/or the like. In some examples, the machine learning model may be trained using the collected data 142.

In some examples, the processor 104 may input the features of the event 114 into the machine learning model and the machine learning model may, based on the features of the event 114, output an indication as to whether the event 114 is anomalous. In some examples, the machine learning model may output an anomaly score associated with the event 114. In these examples, the processor 104 may determine whether the anomaly score exceeds a predefined threshold value. The processor 104 may also determine that the event 114 is anomalous based on a determination that the anomaly score exceeds the predefined threshold value. The predefined threshold value may be set based on historical data, computational modeling, user-defined, and/or the like.

In some examples, the processor 104 may compare the features of the event 114 with the baseline behavior 112 corresponding to those features to determine whether the event 114 is anomalous. By way of particular example in which a feature of the event 114 is a country from which the event 114 originated, the processor 104 may determine that the event 114 is anomalous based on a determination that the country is does not match any of the countries listed in the baseline behavior 112. For instance, the processor 104 may determine that the event 114 is anomalous when the baseline behavior 112 indicates that similar types of events rarely or have never occurred from the country from which the event 114 originated.

In some examples, the processor 104 may determine an anomaly score associated with the event 114 based on the comparison of the features of the event 114 with the baseline behavior 112. For instance, the processor 104 may determine the anomaly score based on which of the features of the event 114 deviate from the baseline behaviors 112 to which the features correspond. The processor 104 may additionally or alternatively determine the anomaly score based on the number of features of the event 114 that deviate from the baseline behaviors 112. Thus, for instance, the processor 104 may assign a higher anomaly score to the events 114 that have features that more greatly deviate from the baseline behavior 112. Likewise, the processor 104 may assign a lower anomaly score to the events 114 that have features that have lower levels of deviation from the baseline behavior 112.

In any of these examples, the processor 104 may determine whether the anomaly score exceeds a predefined threshold value. The processor 104 may also determine that the event 114 is anomalous based on a determination that the anomaly score exceeds the predefined threshold value. The predefined threshold value may be set based on historical data, computational modeling, user-defined, and/or the like.

The processor 104 may execute the instructions 204 to determine at least one feature of the anomalous event 114 that caused the event 114 to be determined to be anomalous. In other words, the processor 104 may determine which features sufficiently deviate from the baseline behaviors 112 to cause the event 114 to be construed as being anomalous. In keeping with the example above, the at least one feature may be geographical location, e.g., country, from which the event 114 originated and/or occurred. In addition, the at least one feature may include a type of application through which the event 114 occurred, a type of entity that performed the event 114, a type of resource associated with the event 114, and/or the like.

The processor 104 may execute the instructions 206 to identify, from the determined baseline behaviors 112, a set of baseline behaviors 116 corresponding to the determined at least one feature of the event 114. The at least one feature may be a feature or features that caused the event 114 to be determined to be anomalous. In addition, the set of baseline behaviors 116 may include normal usage information corresponding to the determined feature(s) of the event 114. The normal usage information may include a top-k seen values, usage statistics, first seen date, a last seen date, a combination thereof, and/or the like. The top-k seen values may include any suitable number of values and may be user-defined. For instance, the top-k seen values may include a top 3 seen values, a top 5 seen values, a top 10 seen values, or other suitable value. In some instances, the actual number of seen values may be lower than the top-k number such as when there are less than the top-k number of baseline behaviors for a particular type of value.

For instance, the top-k seen values may include the top-k types of entities that performed events that are similar or the same as the type of the event 114, the top-k countries from which similar types of events originated and/or occurred, the top-k times of day at which similar types of events occurred, etc. The usage statistics may include the number of times various types of entities performed the similar types of events, the number of times the top-k types of entities performed the similar types of events, the number of times the similar types of events occurred in each of a number of countries, the number of times the similar types of events occurred in each of the top-k countries, a total count of the number of times the similar types of events occurred, etc.

A particular example will now be provided for an event 114 having the following features. In this example, the event 114 is an access to a resource called “Storage_Prod1,” in which the entity that originated or performed the event 114 (“UserAgent”) is a particular type of agent (“PowerShell”), and the country at which the event 114 originated (“SourceCountry”) is Italy. The processor 104 may have determined that the event 114 is anomalous because, based on the baseline behaviors 112 (or from the machine learning mode), accesses to the resource “Storage_Prod1” are normally performed through another type of agent, e.g., “Portal.” The processor 104 may have also determined that the event 114 is anomalous because Italy is not a “SourceCountry” from which accesses to the resource “Storage_Prod1” are normally performed. In this example, the processor 104 may have determined that the features “UserAgent” and the “SourceCountry” associated with the event 114 caused the event 114 to be determined to be anomalous.

In addition, the processor 104 may identify the set of baseline behaviors corresponding to the determined features “UserAgent” and the “SourceCountry” from the baseline behaviors 112. In this example, the processor 104 may identify the top-k types of user agents as listed in the baseline behaviors 112 that have performed the event 114 or a similar type of event. The processor 104 may also identify, from the baseline behaviors 112, a count of the number of times that the top-k types of user agents performed the event 114 or a similar type of event. The processor 104 may further identify a count of the number of times that the particular type of user agent associated with the event 114 performed the event 114 or a similar type of event. The processor 104 may still further identify the last time such a user agent performed the event 114 or a similar type of event.

Furthermore, the processor 104 may identify, from the baseline behaviors 112, the top-k countries from which the event 114 or a similar type of event has originated. The processor 104 may also identify, from the baseline behaviors 112, a count of the number of times that the event 114 or a similar type of event originated from the top-k countries. The processor 104 may further identify a count of the number of times that the event 114 or similar types of events originated from the particular country from which the event 114 originated. The processor 104 may still further identify the last time the event 114 or similar types of events originated from the particular country from which the event 114 originated. [0039] To illustrate the example above, shown below is an example of the identified set of baseline behaviors corresponding to the features “UserAgent” and “SourceCountry” that caused the event 114 to be determined to be anomalous.
“UserAgent”
   Top 3: (“Portal”, count == 3000)
   Anomalous value: (“PowerShell”, count == 0, last seen == None)
   Total count: 3000
“SourceCountry”
   Top 3: (“Israel”, count=1970), (“Spain”, count=500), (“United States”, count=500)
   Anomalous value: (“Italy”, count == 30, last seen == 11.11.2021)
   Total count: 3000

The processor 104 may execute the instructions 208 to generate a message 118, in which the message 118 may include an indication that the anomalous event 114 has been detected. The message 118 may also include the identified set of baseline behaviors 116. Particularly, for instance, the processor 104 may generate the message 118 to include an identification of the anomalous event 114, e.g., an identification of an anomalous access to a resource. By including the identification of the anomalous event 114 and the set of baseline behaviors 116 corresponding to the features that caused the event 114 to be determined to be anomalous in the message 118, the message 118 may provide a recipient, e.g., an end user, of the generated message with context of the anomalous event 114. For instance, the message 118 may provide information regarding the features that caused the event 114 to be determined to be anomalous and may provide information regarding features that are normal. In one regard, the recipient of the message 118 may determine from the message 118 whether the anomalous event 114 is to be further evaluated.

According to examples, the processor 104 may insert the determined set of baseline behaviors 116 into a textual template to generate the message 118. The determined set of baseline behaviors 116 in the textual template may provide a recipient of the generated message 118 with contextual information about the anomalous event 114. Using the example provided above, the processor 104 may insert the determined set of baseline behaviors 116 into a textual template and a few lines of code as shown below.

An anomalous access was detected to resource Storage_Prod1, due to:

“UserAgent” being “PowerShell”, which was never been used before. The most frequent value is “Portal” (100% usage).

“SourceCountry” being “Italy”, which was last seen on 11.11.2021, and used 1% of the time. The most frequent values are “Israel” (65% usage), “Spain” (16% usage), “United States” (16% usage).

As may be noted from the example above, the template may provide the determined set of baseline behaviors 116 in a relatively simple plain text manner. As a result, a recipient of the message 118 may relatively easily determine why an event 114 was determined to be anomalous. Based on this determination, the recipient of the message 118 may determine whether further analysis of the event 114 is warranted. In many instances, recipients of the messages 118 may reduce a number of times that further analysis of anomalous events 114 are performed due to the context regarding the anomalous events 114 provided in the messages 118. For instance, the recipients of the messages 118 may determine from the context provided by the messages 118 whether the anomalous events 114 are potentially malicious or are likely innocuous. As the further analysis of anomalous events 114 may consume computational and energy resources, reductions in the number of further analysis of anomalous events 114 may reduce the consumption of computational and energy resources.

According to examples, the template and/or code may be customized for specific scenarios to, for instance, provide lesser or greater context. The types of statistics collected and included in the baseline behaviors 112 may also be customized for specific scenarios. By way of example, appropriate probabilistic models that describe the probability for an event, e.g., Poisson model for appearance of a new country, confidence interval for an amount of data, etc., may be calculated and added.

In some examples, the processor 104 may determine a plurality of features of the anomalous event 114. For instance, the processor 104 may determine a plurality of features of the anomalous event 114 that caused the event 114 to be determined to be anomalous. The processor 104 may also determine a plurality of baseline behaviors corresponding to the plurality of determined features. In addition, the processor 104 may prioritize the determined plurality of baseline behaviors. For instance, each of the baseline behaviors may be assigned a value associated with the respective importance of the baseline behaviors. Thus, for instance, the “UserAgent” may have a higher value than the “SourceCountry” or vice versa. As another example, the time at which the event 114 occurred may be assigned a lower value than the “SourceCountry.” In some examples, a user or administrator may assign the values to the baseline behaviors according to perceived or known levels of importance attributable to the baseline behaviors.

According to examples, the processor 104 may identify a top predefined number of the determined plurality of baseline behaviors from the prioritized plurality of baseline behaviors as the identified set of baseline behaviors 116. The predefined number may be user-defined, based on a number of baseline behaviors to be included in a template, and/or the like.

The processor 104 may execute the instructions 210 to output the generated message 118. The processor 104 may output the generated message 118 in any of a number of various manners. For instance, the processor 104 may output the generated message 118 through a dedicated app. As another example, the processor 104 may generate a link to an app that includes the message 118 and the processor 104 may communicate the link to a recipient of the message 118. For instance, the processor 104 may include the link in an email message and/or a text message and may communicate the email message and/or the text message to the recipient. The recipient may be required to enter a set of authentication credentials in order to access the information that is accessible via the link in order to secure the information. The recipient may be, for instance, an administrator of an organization, an IT personnel of an organization, an individual user, and/or the like.

Although the instructions 200-210 are described herein as being stored on the memory 106 and may thus include a set of machine-readable instructions, the apparatus 102 may include hardware logic blocks that may perform functions similar to the instructions 200-210. For instance, the processor 104 may include hardware components that may execute the instructions 200-210. In other examples, the apparatus 102 may include a combination of instructions and hardware logic blocks to implement or execute functions corresponding to the instructions 200-210. In any of these examples, the processor 104 may implement the hardware logic blocks and/or execute the instructions 200-210. As discussed herein, the apparatus 102 may also include additional instructions and/or hardware logic blocks such that the processor 104 may execute operations in addition to or in place of those discussed above with respect to FIG. 2.

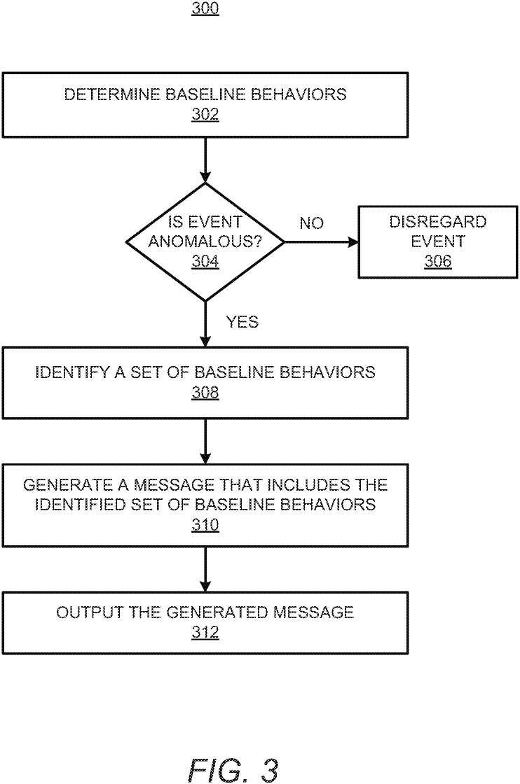

Various manners in which the processor 104 of the apparatus 102 may operate are discussed in greater detail with respect to the method 300 depicted in FIG. 3. Particularly, FIG. 3 depicts a flow diagram of a method 300 for generating and outputting a message 118 that includes an identified set of baseline behaviors 116 that correspond to at least one feature of an anomalous event 114, in accordance with an embodiment of the present disclosure. It should be understood that the method 300 may include additional operations and that some of the operations described therein may be removed and/or modified without departing from the scope of the method 300. The description of the method 300 is made with reference to the features depicted in FIGS. 1 and 2 for purposes of illustration.

At block 302, the processor 104 may determine baseline behaviors 112 from collected data 142. As discussed herein, the processor 104 may determine the baseline behaviors 112 directly or may determine the baseline behaviors 112 through receipt of the baseline behaviors 112 from the network entity 140.

At block 304, the processor 104 may determine whether an event 114 is anomalous based on features of the event 114. As discussed herein, the processor 104 may apply a machine learning model to the features of the event 114, in which the machine learning model is to determine whether the event 114 is anomalous based on the features of the event 114. In addition, or alternatively, the processor 104 may determine an anomaly score associated with the event 114. The processor 104 may also determine whether the anomaly score exceeds a predefined threshold value. The processor 104 may further determine that the event 114 is anomalous based on a determination that the anomaly score exceeds the predefined threshold value.

Based on a determination that the event 114 is not anomalous, at block 306, the processor 104 may disregard the event 114. However, based on a determination that the event 114 is anomalous, at block 308, the processor 104 may identify, from the determined baseline behaviors 112, a set of baseline behaviors 116 corresponding to at least one of the features of the anomalous event 114. In some examples, the processor 104 may determine which of the features of the anomalous event 114 caused the event 114 to be determined to be anomalous. In these examples, the processor 104 may identify the set of baseline behaviors 116 as the set of baseline behaviors 116 that correspond to at least one feature of the features of the event 114 that caused the event 114 to be determined to be anomalous.

In some examples, the processor 104 may determine a plurality of baseline behaviors 116 corresponding to the determined features that caused the event 114 to be determined to be anomalous. The processor 104 may also prioritize the determined plurality of baseline behaviors, for instance, according to importance values assigned to the baseline behaviors. The processor 104 may further identify a top predefined number of the determined plurality of baseline behaviors from the prioritized plurality of baseline behaviors as the identified set of baseline behaviors 116.

At block 310, the processor 104 may generate a message 118 that includes the identified set of baseline behaviors 116. For instance, the processor 104 may generate the message to include an indication as to how the anomalous event 114 differs from the determined set of baseline behaviors. In addition, the processor 104 may insert the determined set of baseline behaviors 116 into a textual template to generate the message 118.

At block 312, the processor 104 may output the message 118 to provide a recipient of the message 118 with contextual information pertaining to the anomalous event 114.

Some or all of the operations set forth in the method 300 may be included as utilities, programs, or subprograms, in any desired computer accessible medium. In addition, the method 300 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

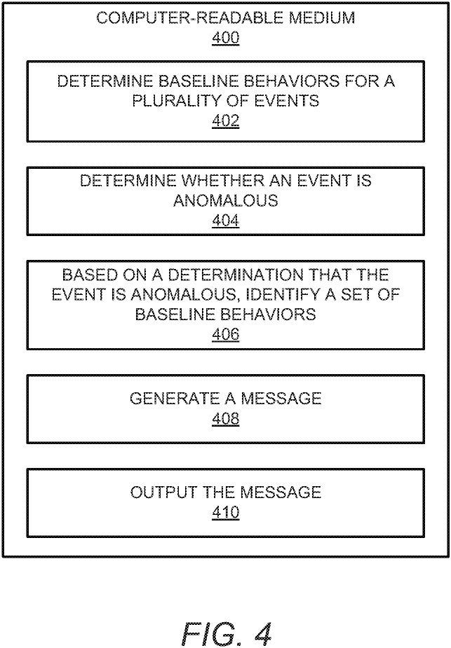

Turning now to FIG. 4, there is shown a block diagram of a computer-readable medium 400 that may have stored thereon computer-readable instructions for generating and outputting a message 118 that includes an identified set of baseline behaviors 116 that correspond to at least one feature of an anomalous event 114, in accordance with an embodiment of the present disclosure. It should be understood that the computer-readable medium 400 depicted in FIG. 4 may include additional instructions and that some of the instructions described herein may be removed and/or modified without departing from the scope of the computer-readable medium 400 disclosed herein. The computer-readable medium 400 may be a non-transitory computer-readable medium, in which the term “non-transitory” does not encompass transitory propagating signals.

The computer-readable medium 400 may have stored thereon computer-readable instructions 402-410 that a processor, such as a processor 104 of the apparatus 102 depicted in FIGS. 1 and 2, may execute. The computer-readable medium 400 may be an electronic, magnetic, optical, or other physical storage device that contains or stores executable instructions. The computer-readable medium 400 may be, for example, Random Access memory (RAM), an Electrically Erasable Programmable Read-Only Memory (EEPROM), a storage device, an optical disc, and the like.

The processor may fetch, decode, and execute the instructions 402 to determine baseline behaviors 112 for a plurality of events 120a-120n from data 142 collected about the plurality of events 120a-120n. As discussed herein, the processor 104 may determine the baseline behaviors 112 directly or may determine the baseline behaviors 112 through receipt of the baseline behaviors 112 from the network entity 140.

The processor may fetch, decode, and execute the instructions 404 to determine, from at least one feature of an event 114, whether the event 114 is anomalous. The processor may determine whether the event 114 is anomalous in any of the manners discussed herein.

The processor may fetch, decode, and execute the instructions 406 to, based on a determination that the event 114 is anomalous, identify, from the determined baseline behaviors 112, a set of baseline behaviors 116 corresponding to the determined at least one feature. The processor may identify the set of baseline behaviors 116 corresponding to the determined at least one feature in any of the manners discussed above.

The processor may fetch, decode, and execute the instructions 408 to generate a message 118 to include an indication that the anomalous event 114 has been detected and the identified set of baseline behaviors 116.

The processor may fetch, decode, and execute the instructions 410 to output the generated message 118.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims – and their equivalents – in which all terms are meant in their broadest reasonable sense unless otherwise indicated.

What is claimed is:

1. An apparatus comprising:
a processor; and
a memory on which is stored machine-readable instructions that when executed by the processor, cause the processor to:
determine baseline behaviors from collected data;
detect that an anomalous event has occurred;
determine at least one feature of the anomalous event that caused the event to be determined to be anomalous;
identify, from the determined baseline behaviors, a set of baseline behaviors corresponding to the determined at least one feature;
generate a message to include:
an indication that the anomalous event has been detected; and
the identified set of baseline behaviors; and
output the generated message.

2. The apparatus of claim 1, wherein the processor is to:
determine a plurality of features of the anomalous event;
determine a plurality of baseline behaviors corresponding to the plurality of determined features;
prioritize the determined plurality of baseline behaviors; and
identify a top predefined number of the determined plurality of baseline behaviors from the prioritized plurality of baseline behaviors as the identified set of baseline behaviors.

3. The apparatus of claim 1, wherein the set of baseline behaviors comprises a top-k seen value of the at least one feature of the event, usage statistics of the at least on feature of the event, a first seen date of the event, a last seen date of the event, or a combination thereof.

4. The apparatus of claim 1, wherein the processor is to:
generate the message to include an indication as to how the at least one feature of the anomalous event differs from the determined set of baseline behaviors.

5. The apparatus of claim 1, wherein the processor is to:
insert the determined set of baseline behaviors into a textual template to generate the message, wherein the determined set of baseline behaviors in the textual template provides a recipient of the generated message with contextual information about the anomalous event.

6. The apparatus of claim 1, wherein the processor is to:
determine that the at least one feature of the event is anomalous with respect to at least one of the determined baseline behaviors to detect that the anomalous event has occurred.

7. The apparatus of claim 1, wherein the processor is to:
determine an anomaly score associated with the event;
determine whether the anomaly score exceeds a predefined threshold value; and
determine that the event is anomalous based on a determination that the anomaly score exceeds the predefined threshold value.

8. The apparatus of claim 1, wherein the processor is to:
apply a machine learning model to features of the event, wherein the machine learning model is to determine whether the event is anomalous based on the features of the event.

9. The apparatus of claim 8, wherein the machine learning model is trained using the collected data.

10. A method comprising:
determining, by a processor, baseline behaviors from collected data;
determining, by the processor, whether an event is anomalous based on features of the event;
identifying, by the processor and from the determined baseline behaviors, a set of baseline behaviors corresponding to at least one of the features of the anomalous event;
generating, by the processor, a message that includes the identified set of baseline behaviors; and
outputting, by the processor, the message to provide a recipient of the message with contextual information pertaining to the anomalous event.

11. The method of claim 10, further comprising:
determining which of the features of the anomalous event caused the event to be determined to be anomalous; and
identifying the set of baseline behaviors as the set of baseline behaviors that correspond to at least one feature of the features of the event that caused the event to be determined to be anomalous.

12. The method of claim 11, further comprising:
determining a plurality of baseline behaviors corresponding to the determined features that caused the event to be determined to be anomalous;
prioritizing the determined plurality of baseline behaviors; and
identifying a top predefined number of the determined plurality of baseline behaviors from the prioritized plurality of baseline behaviors as the identified set of baseline behaviors.

13. The method of claim 10, further comprising:
generating the message to include an indication as to how the anomalous event differs from the determined set of baseline behaviors.

14. The method of claim 10, further comprising:
inserting the determined set of baseline behaviors into a textual template to generate the message.

15. The method of claim 10, further comprising:
determining an anomaly score associated with the event;
determining whether the anomaly score exceeds a predefined threshold value; and
determining that the event is anomalous based on a determination that the anomaly score exceeds the predefined threshold value.

16. The method of claim 10, further comprising:
applying a machine learning model to features of the event, wherein the machine learning model is to determine whether the event is anomalous based on the features of the event.

17. A computer-readable medium on which is stored computer-readable instructions that when executed by a processor, cause the processor to:
determine baseline behaviors for a plurality of events from data collected about the plurality of events;
determine, from at least one feature of an event, whether the event is anomalous; and
based on a determination that the event is anomalous,
identify, from the determined baseline behaviors, a set of baseline behaviors corresponding to the determined at least one feature;
generate a message to include:
an indication that the anomalous event has been detected; and
the identified set of baseline behaviors; and
output the generated message.

18. The computer-readable medium of claim 17, wherein the instructions further cause the processor to:
determine a plurality of baseline behaviors corresponding to the determined features;
prioritize the determined plurality of baseline behaviors; and
identify a top predefined number of the determined plurality of baseline behaviors from the prioritized plurality of baseline behaviors as the identified set of baseline behaviors.

19. The computer-readable medium of claim 17, wherein the instructions further cause the processor to:
insert the determined set of baseline behaviors into a textual template to generate the message, wherein the determined set of baseline behaviors in the textual template is to provide a recipient of the generated message with context of the anomalous event.

20. The computer-readable medium of claim 17, wherein the instructions further cause the processor to:
determine an anomaly score associated with the event;
determine whether the anomaly score exceeds a predefined threshold value; and
determine that the event is anomalous based on a determination that the anomaly score exceeds the predefined threshold value.
